(19) United States
(12) Patent Application Publication
(10) Pub. No.: US 2013/0260080 A1
(43) Pub. Date: Oct. 3, 2013

(54) IN-SITU FOAM CORE STRUCTURAL ARTICLES AND INJECTION MOLDING METHODS OF MANUFACTURE

(71) Applicant: Richard W. Roberts, Tecumseh, MI (US)

(72) Inventor: Richard W. Roberts, Tecumseh, MI (US)

(21) Appl. No.: 13/463,710

(22) Filed: May 3, 2012

Related U.S. Application Data
(60) Provisional application No. 61/617,035, filed on Mar. 28, 2012.

(51) Int. Cl. B29C 44/08; B32B 3/26

(52) U.S. Cl. CPC B29C 44/08; B32B 3/26
USPC 428/71; 264/48

(57) ABSTRACT

A method for manufacturing a plastic structural article is disclosed that includes the steps of injecting a molten polymer composition through a nozzle into a mold having a first and a second mold portions defining a first cavity within the mold. A first fluid is injected into the first cavity that is partially filled with the molten polymer composition, pushing the molten polymer composition towards the walls of mold and a spillover trap forming a second cavity. The walls are cooled by the first fluid, which then removed. An aperture is cut in the wall. A plurality of pre-expanded beads is introduced through the aperture into the second cavity. The pre-expanded beads are expanded by injecting a second fluid forming an in-situ foam core thermally bonded to the wall. The plastic structural article is released from the mold. The structural plastic articles are also disclosed.

### CROSS-REFERENCE TO RELATED APPLICATIONS

This application claims the benefit of U.S. provisional Application No. 61/617,035 filed Mar. 28, 2012, the disclosure of which is incorporated in its entirety by reference herein.

### TECHNICAL FIELD

The disclosed embodiments relate to recyclable in-situ foam core plastic structural articles and injection molding methods of manufacture of same.

### BACKGROUND

Plastic processors who use injection molding methods continue to reduce the amount of plastic material used in every part molded in order to reduce the cost of materials as well as the cycle time of the injection molding equipment. Often, reducing the amount of material used results in weaker structural properties for the finished article.

Plastic processors have developed processes to reduce the amount of material during injection molding by creating an internal cavity in the article during injection molding. When the article has the internal cavity, plastic processors will often improve the structural properties of the finished article by removing the article having the core from the injection molding machine and place the article in a fixture. When in a fixture, a foam core is injected into or adhered to the article in order to fill the cavity. This process includes a secondary operation that increases the cost of the article.

Certain processes that create bodies that, at least, partially fill the cavity need extended time periods for foaming which is not economically justified in view of the costly lost machine time when the injection molding equipment is not actively engaged in injection molding articles. In addition, in certain processes, the plastic material of the injection molded article is different from the plastic material used for the foam core rendering the article uneconomical to recycle. Recycling of articles after completion of their useful life is increasingly desirable for sustainability objectives as well as being included in certain regulations.

### SUMMARY

In at least one embodiment, an article is recited that includes a wall defining a cavity. Disposed within the cavity is an in-situ foam core having a thermal bond to the wall. The article is structural and the in-situ foam core density ranges from 0.2 lb/ft³ to 20 lbs/ft³.

In another embodiment, a method for manufacturing a plastic structural article is recited that includes the steps of injecting a molten polymer composition through a nozzle into a mold having a first and a second mold portions defining a first cavity within the mold. A first fluid is injected into the first cavity that is partially filled with the molten polymer composition, pushing the molten polymer composition towards the walls of mold and a spillover trap forming a second cavity. The walls are cooled by the first fluid, which then removed. An aperture is cut in the wall. A plurality of pre-expanded beads is introduced through the aperture into the second cavity. The pre-expanded beads are expanded by injecting a second fluid forming an in-situ foam core thermally bonded to the wall. The plastic structural article is released from the mold. The structural plastic articles are also disclosed.

### BRIEF DESCRIPTION OF THE DRAWINGS

FIGS. 1A-1E schematically illustrate a method of producing a structural article having an in-situ foam core according to at least one embodiment;

FIGS. 2A-2B schematically illustrates cross-sectional views of structural hollow profiles having in-situ foam core according to at least one embodiment;

FIGS. 3A-3E schematically illustrate a method of producing a plastic structural article having an in-situ foam core according to at least one embodiment;

FIGS. 4A-4E schematically illustrates a method of producing a plastic structural article an in-situ foam care according to another embodiment; and

FIGS. 5A-5B schematically illustrates cross-sectional views of structural articles having an in-situ foam core according to at least one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in the description and claims, indicated amounts of material or conditions of reaction and/or use are to be understood as modified by the word “about” in describing the broadest scope of the present invention. Practice within the numerical limits stated should be desired and independently embodied. Ranges of numerical limits may be independently selected from data provided in the tables and description. The description of the group or class of materials as suitable for the purpose in connection with the present invention implies that the mixtures of any two or more of the members of the group or classes are suitable. The description of constituents in chemical terms refers to the constituents at the time of addition to any combination specified in the description and does not necessarily preclude chemical interaction among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same techniques previously or later referenced for the same property. Also, unless expressly stated to the contrary, percentage, “parts of,” and ratio values are by weight, and the term “polymer” includes “oligomer,” “co-polymer,” “terpolymer,” “pre-polymer,” and the like.

It is also to be understood that the invention is not limited to specific embodiments and methods described below, as specific composite components and/or conditions to make, of course, vary. Furthermore, the terminology used herein is used only for the purpose of describing particular embodiments of the present invention and is not intended to be limiting in any way.

It must also be noted that, as used in the specification and the pending claims, the singular form “a,” “an,” and “the,” comprise plural reference unless the context clearly indicates otherwise. For example, the reference to a component in the singular is intended to comprise a plurality of components.

Throughout this application, where publications are referenced, the disclosure of these publications in their entirety are hereby incorporated by reference into this application to more fully describe the state-of-art to which the invention pertains.

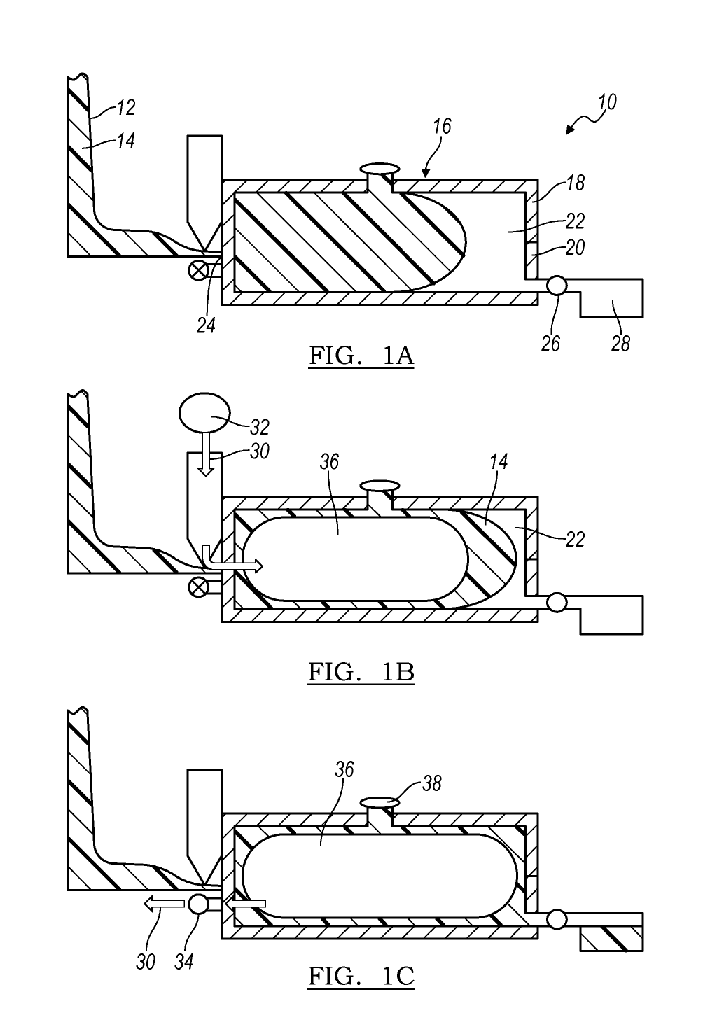

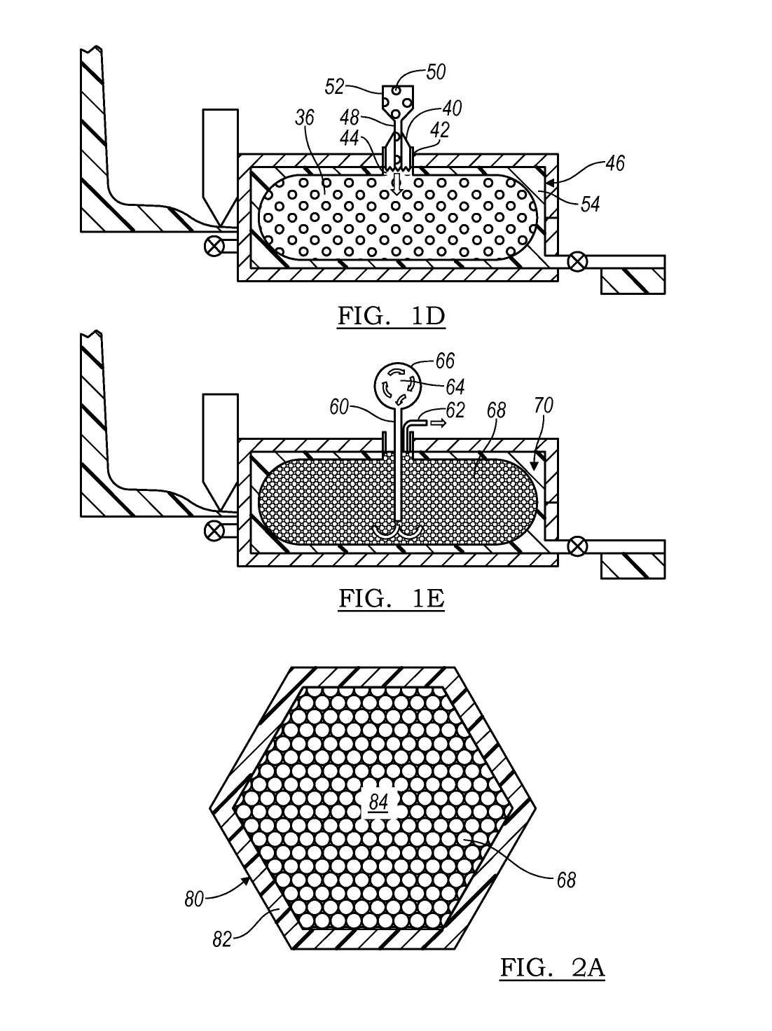

FIGS. 1A-1E schematically illustrate a method of producing a plastic structural article having an in-situ foam core according to at least one embodiment. Regarding FIG. 1A, step 10 has a nozzle 12 containing a molten polymer composition 14. Molten polymer composition 14 is injection molded into a mold 16 having a first mold portion 18 and a second mold portion 20. The first and second mold portions 18 and 20, respectively, define a cavity 22 within the mold 16 into which molten polymer composition 14 is being injected through at least one sprue 24.

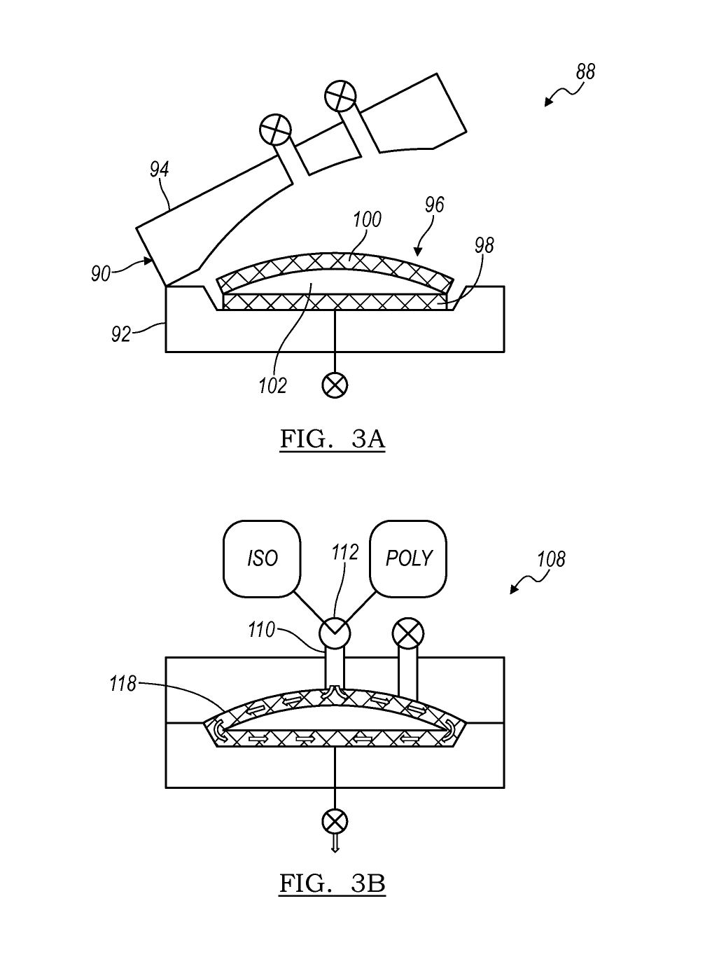

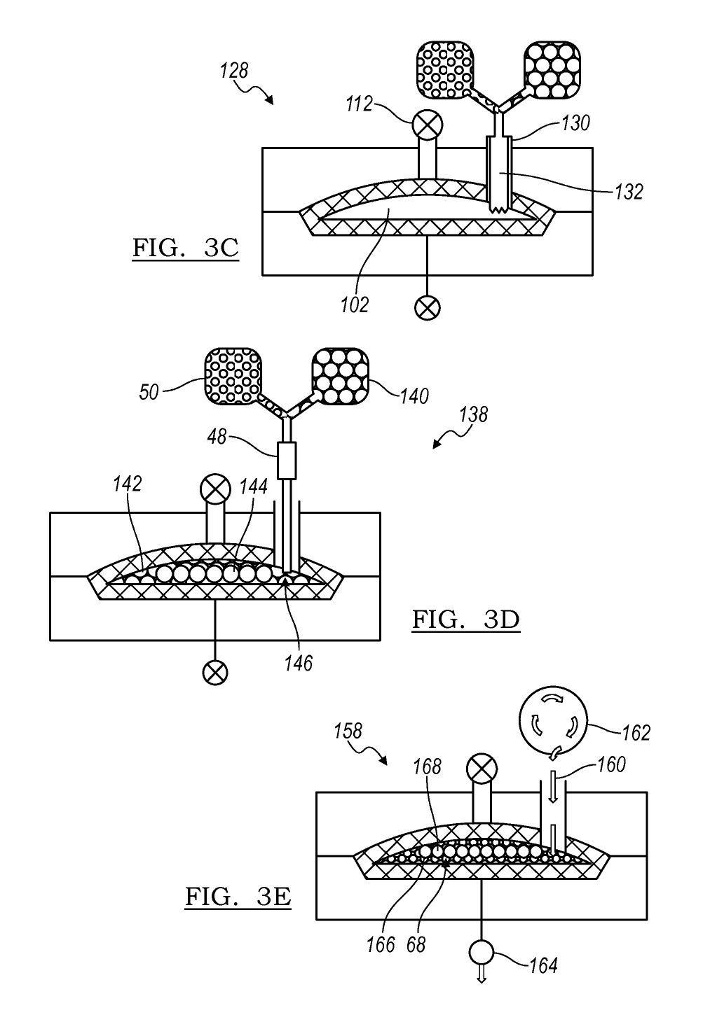

FIG. 1B includes having a fluid 30 from a fluid source 32 enter mold cavity 22 which is now, at least, partially filled with molten polymer 14 by pushing molten polymer 14 towards the walls of mold 16. When molten polymer 14 is pushed completely to the wall of mold 16 by the fluid 30 in FIG. 3C, a cavity 36 is formed inside the injection molding shot of molten polymer 14 and excess molten polymer 14 is displaced into a spillover trap 28 through valve 26 (FIG. 1A). Fluid 30 cools molten polymer 14 sufficiently such that a hollow article 46 is self-supporting. Fluid 30 is removed from cavity 36 through a vent 34. Vent 34 and valve 26 are subsequently closed.

The steps of FIGS. 1A-C are illustrated by U.S. Pat. No. 6,375,892 which is incorporated herein by reference.

FIG. 1D has a port cap 38 (FIG. 1C) removed and includes a rotary cutter 40 that passes through a mold port 42 cutting an aperture 44 in a wall 54 of the hollow article 46. Rotary cutter 40 withdraws from aperture 44 and a bead dispenser 48 enters aperture 44. Valve 26 is closed.

In FIG. 1D, pre-expanded beads 50 are dispensed from a bead source 52 to bead dispenser 48 and from bead dispenser 48 into cavity 36 of hollow article 46. Bead dispenser 48 withdraws from aperture 44.

In FIG. 1E, a steam pin 60 and a steam vent 62 are inserted into aperture 44. Steam 64 from steam source 66 is injected into cavity 36 causing rapid expansion of pre-expanded beads 50 which tightly pack cavity 36 forming an in-situ foam core 68 which has a thermal bond with wall 54. A plastic structural article 70 having a wall 54 formed of a cooled polymer and in-situ foam core 68 is released from mold 16 by separating the first mold portion 18 from the second mold portion 20.

In at least one embodiment, the thermal bond includes a molten or softened portion of wall 54, a molten or softened portion of in-situ foam core 68, and a co-mingled layer therebetween comprising wall 54 and in-situ foam core 68.

The steps of FIGS. 1D-E are illustrated by U.S. patent application Ser. Nos. 13/358,181, 13/005,190, and 12/913,132 all of which are incorporated herein by reference.

In at least one embodiment, wall 54 thickness may range from 0.03 inches to 0.5 inches. In another embodiment, the thickness of wall 54 may range from 0.075 inches to 0.25 inches.

In at least one embodiment, in-situ foam core 68 thickness may range from 0.15 inches to 6 inches. In another embodiment, in-situ foam core 68 thickness may range from 0.2 inches to 4 inches. In another embodiment, in-situ foam core 68 thickness may range from 0.5 inches to 1 inch.

In at least one embodiment, in-situ foam core 68 length or width dimension is greater than 0.15 inches. In another embodiment, in-situ foam core 68 length or width dimension ranges from 0.15 inches to 100 inches. In another embodiment, in-situ foam core 68 length or width dimension ranges from 1 inch to 85 inches. In another embodiment, in-situ foam core 68 length or width dimension ranges from 4 inches to 40 inches.

Hollow article 46, in at least one embodiment, is formed of a composition of any injection-moldable composition. Non-limiting examples of the injection-moldable composition include, but is not limited to, a liquid silicone rubber, a synthetic rubber, a natural rubber, a liquid crystal polymer, a metal matrix composite, a pre-generated micocomposite in a matrix, a ceramic powder in a polymer binder, a synthetic polymer resin, and a natural polymer resin. In another embodiment, hollow article 46 is formed of a composition of a thermoplastic polymer, a thermoset polymer, or blends thereof having viscosity ranging from 10 grams/10 min to 40 grams/10 min such as polymers intended for use with injection molding. The viscosity is measured according to ASTM D-1238 at 190° C. with a 2.16 kg weight. In yet another embodiment, hollow article 46 is formed of a composition of a polyolefin including polypropylene and polyethylene having viscosity ranging from 12 grams/10 min to 30 grams/10 min.

In-situ foam core 68, in at least one embodiment, is formed of a composition of any fluid-expandable material. Examples of fluid-expandable material include, but are not limited to, a polyolefin polymer composition, a biopolymer expandable bead, an alkenyl aromatic polymer or copolymer, a vinyl aromatic polymer resin composition, and a polystyrene polymer composition. In at least one embodiment, the polyolefin polymer composition includes polyolefin homopolymers, such as low-density, medium-density, and high-density polyethylenes, isotactic polypropylene, polybutylene-1, and copolymers of ethylene or polypropylene with other polymerized bull monomers such as ethylene-propylene copolymer, and ethylene-vinyl acetate copolymer, and ethylene-acrylic acid copolymer, and ethylene-ethyl acrylate copolymer, and ethylene-vinyl chloride copolymer. These polyolefin resins may be used alone or in combination. Preferably, expanded polyethylene (EPE) particles, cross-linked expanded polyethylene (xEPE) particles, polyphenyloxide (PPO) particles, biomaterial particles, such as polylactic acid (PLA), and polystyrene particles are used. In at least one embodiment, the polyolefin polymer is a homopolymer providing increased strength relative to a copolymer. It is also understood that some of the particles may be unexpanded, also known as pre-puff, partially and/or wholly pre-expanded without exceeding the scope or spirit of the contemplated embodiments.

Pre-expanded bead 50, in at least one embodiment, is the resultant bead after the first expansion step of raw bead of a two-step expansion process for beads. During the first expansion step, raw bead is expanded to 2% to 95% of the fully expanded bead size. The fully expanded bead is the bead that forms in-situ foam core 68. In another embodiment, pre-expanded bead 50 is result of the first expansion step where raw bead is expanded from 25% to 90% of the fully expanded bead size.

A fluid for the second expansion step of the two-step expansion process for beads causes the pre-expanded beads to expand completely to form the fully expanded beads. Examples of the fluid includes, but are not limited to, steam and superheated steam.

Polyolefin beads and methods of manufacture of pre-expanded polyolefin beads suitable for making the illustrated embodiments are described in Japanese patents JP60090744, JP59210954, JP59155443, JP58213028, and U.S. Pat. No. 4,840,973 all of which are incorporated herein by reference. Non-limiting examples of expanded polyolefins are ARPLANK® and ARPRO® available from JSP, Inc. (Madison Heights, Mich.). The expanded polypropylene, such as the JSP ARPROTS EPP, has no external wall such as wall 54.

In at least one embodiment, in-situ foam core 68 density, after expansion by steam such as in FIGS. 1E and 3E, ranges from 0.2 lb/ft³ to 20 lbs/ft³. In at least one embodiment, in-situ foam core 68 density, after expansion by steam such as in FIGS. 1E and 3E, ranges from 1 lbs/ft³ to 15 lbs/ft³. In at least one embodiment, in-situ foam core 68 density, after expansion by steam such as in FIGS. 1E and 3E, ranges from 2 lbs/ft³ to 9 lbs/ft³. In at least one embodiment, in-situ foam core 68 density, after expansion by steam such as in FIGS. 1E and 3E, ranges from 3 lbs/ft³ to 6 lbs/ft³.

Preferably, in at least one embodiment, steam-injected expanded polypropylene (EPP) has a density ranging from 0.2 lb/ft³ to 20 lbs/ft³. In yet another embodiment, steam-injected EPP may have a density ranging from 1 lbs/ft³ to 10 lbs/ft³. In yet another embodiment, steam-injected EPP may have a density ranging from 2 lbs/ft³ to 6 lbs/ft³. In yet another embodiment, steam injected EPP may have a density ranging from 3 lbs/ft³ to 5 lbs/ft³.

Injection molding processes suitable for forming hollow article 46 include but are not limited to co-injection molding, lost core injection molding, internal gas-assisted injection molding, external gas-assisted injection molding, injection-compression molding, insert injection molding, outsert injection molding, low-pressure injection molding, metal injection molding, powder injection molding, overmolding injection molding, multicomponent injection molding, push-pull injection molding, reaction injection molding (RIM), structural reaction injection molding (SRIM), reinforced reaction injection molding (RRIM), powder injection molding, thin-wall molding, rubber injection molding, liquid silicone rubber injection molding, and molding where chemical and/or physical blowing agents activities are enhanced when the mold is partially opened after initial injection.

In at least one embodiment, thin-wall molding may produce a hollow article 46 having a wall thickness ranging from 1.2 mm to 2.5 mm. Thin-wall molding parts freeze off quickly and therefore require high melt temperatures, high injection speeds and very high injection pressures to avoid anisotropic shrinkage. Surprisingly, the rapid expansion of pre-expanded bead 50 by steam 64 as well as the high degree of packing of in-situ foam core 68 when expanded in a mold results in thin-wall molded articles that do not exhibit read-through of the bead structures in the thin-wall article exterior. The thin-wall article having in-situ foam core 68 provides the same or greater mechanical strength as conventional parts having wall thicknesses ranging from 2 to 4 mm thick.

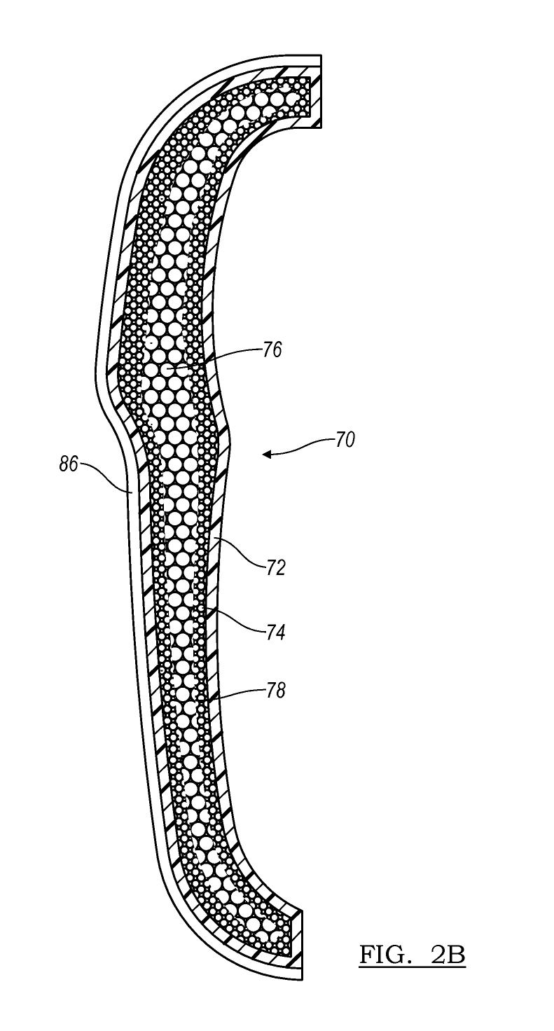

Turning now, to FIG. 2A, a structural hollow profile having the in-situ foam core is schematically illustrated according to at least one embodiment. Structural articles have sufficient stiffness and strength to allow use in load-bearing applications. In at least one embodiment, the article has a compressive strength greater than 2000 lbf/in². In another embodiment the articles has a compressive strength greater than 3000 lbf/in². A hollow profile 80 is formed using at least one of the injection molding methods disclosed above. A wall 82 of hollow profile 80 defines a cavity 84 into which a single density of pre-expanded bead 50 has been expanded to form in-situ foam core 68. The fully expanded beads are thermally bonded to wall 82. The hollow profile 80 having the in-situ foam core 68 surprisingly forms a structural article. In at least one embodiment, wall 82 comprises a plastic polymer composition which in combination with in-situ foam core 68 forming a structural plastic article. In at least one embodiment, the structural plastic article is suitable for forming a structural assembly. It is understood that while a hexagonal-shaped structural article is illustrated in FIG. 2A, any suitable shape having a cavity may be used without exceeding the scope or spirit of embodiments. Non-limiting examples of suitable shapes include an I-beam and a sphere.

In at least one embodiment, wall 82 has a polymeric composition that is identical to the polymeric composition of in-situ foam core 68, advantageously rendering the structural plastic article recyclable. A non-limiting example of such a recyclable structural plastic article includes one having wall 82 comprised of polyethylene and in-situ foam core 68 comprised of expanded polyethylene beads. In another embodiment, wall 82 has a polymeric composition that is sufficiently similar to the polymeric composition of in-situ foam core 68 to render still the structural article recyclable. A non-limiting example of such a recyclable article having similar compositions between the wall 82 and the in-situ foam core 68 includes having wall 82 comprising acrylonitrile butadiene styrene (ABS) and in-situ foam core 68 comprising expanded polystyrene.

In at least one embodiment, as shown in FIG. 2B, a refrigerator handle 70 is schematically illustrated. Refrigerator handle 70 includes an injection-molded skin 72 defining cavity into which in-situ foam core 74 is formed having a relatively less dense zone 76 and a relatively denser zone 78 of fully expanded beads. Refrigerator handle 70 must have show surfaces on all exterior portions. In at least one embodiment, skin 72 comprises show surfaces on all exterior portions. A decorative layer 86 is attached to skin 72 in at least one embodiment. Decorative layer 86 may be applied in a secondary operation when refrigerator handle 70 is removed from mold 16 or may be applied as an in-mold decoration in mold 16.

FIGS. 3A-3E illustrate schematically a method of producing a plastic structural article having an in-situ foam core according to at least one embodiment. FIG. 3A shows a first step 88 in the structural reaction injection molding (SRIM) process. A book press 90 includes a first book press portion 92 and a second book press portion 94 defining a cavity 96. Into cavity 96, a first fiberglass preform portion 98 and a second fiberglass preform portion 100 are provided forming a cavity 102 therebetween. A collapsible core (not shown) is optionally available to assist in maintaining cavity 102 during resin-filling operations disclosed in FIG. 3B.

In FIG. 3B, step 108 schematically illustrates that gate 110 which passes through the second book press portion and fluidly communicates with the first fiberglass preform portion 98. A valve 112 connected to gate 110 is opened to allow an isocyanate-containing composition to be injected into the cavity 96 from an isocyanate source 114. Valve 112 also allows a polyol-containing composition to be injected into cavity 96 from a polyol source 116. The isocyanate-containing composition reacts with the polyol-containing composition to form, in at least one embodiment, a resin of a polyurethane composition which flowed out into the first fiberglass preform portion and the second fiberglass preform portion to form a structural SRIM article 118. It is understood that while polyurethane is used in the example, any heterochain condensation polymer may be used for the resin.

Non-limiting examples of heterochain condensation polymers include a polyoxide polymer, such as an acetal polymer, a polyester polymer, a polyamide polymer, a polyuria polymer, a polyimide polymer, a polyimine polymer, a polycarbonate polymer, a polysiloxane polymer, and blends thereof.

In FIG. 3C, step 128 schematically illustrates that valve 112 is closed and structural SRIM article 118 begins to cure. Through a gate 130 that connects to structural SRIM article 118, a cutter 132 bores through structural SRIM article 118 into cavity 102.

In FIG. 3D, step 138 schematically illustrates that cutter 132 is withdrawn and bead dispenser 48 is inserted into cavity 102. The first pre-expanded beads 50 are injected into cavity 102. A second pre-expanded beads 140 are injected into cavity 102. The first pre-expanded beads 50 have a smaller diameter than the second pre-expanded beads 140. In at least one embodiment, the first pre-expanded beads 50 form a first layer within cavity 102. And the second pre-expanded beads 144 form a second layer adjacent to the first layer within cavity 102. It should be understood that there may be a plurality of layers without exceeding the scope or spirit of embodiments. It should be further understood, that the layers may be intermingled having substantially one type of pre-expanded bead in portions of the layer. It should also be further understood, that there may be a plurality of types of pre-expanded beads provided to cavity 102 in certain embodiments.

In FIG. 3E, step 158 schematically illustrates that the bead dispenser 48 is withdrawn and steam 160 from a steam source 162 is injected into the beads within cavity 102, in at least one embodiment, before the polyurethane composition cures. Any residual steam 160 or condensed water from steam 160 is vented through valve 164. The pre-expanded beads 50 and 144 completely expand to become fully expanded beads 166 and 168, respectively, after being exposed to the steam 160. As a consequence of the relative difference in diameter of the original pre-expanded beads 50 and 144, the first pre-expanded beads 50 having an initially smaller diameter and form a more dense portion 142 of in-situ foam core 68 than a second portion 146 of in-situ foam core 68 where the second pre-expanded beads 144 having initially larger bead diameters relative to first pre-expanded beads 50, are injected. The difference in density between the more dense portion 142 of in-situ foam core 68 and the portion 146 of the in-situ foam core 68 is at least 1 lb/ft³, in at least one embodiment.

The structural SRIM article having the in-situ foam core 68 may be removed by opening first book press portion 92 from second book press portion 94. It is surprisingly advantageous to have in-situ foam core 68 because the thickness of the first and/or second fiberglass preform portion 98 and 100, respectively, may be reduced from conventional thicknesses. Reduction in the thickness of the fiberglass preform portion 98 and/or 100 improves the completeness of wetting out of the fiberglass preform portions 98 and/or 100 reducing the chance of structural deficiencies resulting from air pockets in the fiberglass preform portions 98 and/or 100 resulting in incomplete wetness of the fiberglass preform portions 98 and/or 100.

The heating mechanism, such as steam 64 or 160, is supplied in FIGS. 1E and 3E from steam source 66 or 162, respectively, in at least one embodiment. As a non-limiting example, steam 64 is directed to a plurality of steam ports, such as steam pin 60. When there is a plurality of steam pins 60, spacing between steam pins 60 may vary with the density of unexpanded beads because the steam migration is limited. In at least one embodiment, the spacing between adjacent steam pins 60 ranges from 1 inch to 6 inches. In another embodiment, the spacing between adjacent steam pins 60 ranges from 2 inches to 5 inches. In yet another embodiment, the spacing between adjacent steam pins 60 ranges between the distances defined by equations [1] and [2]

$$\begin{matrix}{D}_{1} = \frac{1}{ABD \times 0.56} - 0.5 & [ 1 ] \\ {D}_{2} = \frac{1}{ABD \times 5} + 3 & [ 2 ]\end{matrix}$$

wherein D₁ is the minimum distance in inches between steam pins 60 and D₂ is the maximum distance in inches between steam pins 60, ABD is an average apparent bulk density of unexpanded and/or partially expanded polymer particles suitable for comprising in-situ foam core 68.

In at least one embodiment, the average apparent bulk density of the pre-expanded beads 50 ranges from 0.15 lbs/ft³ to 4 lbs/ft³. In another embodiment, the average apparent bulk density of the pre-expanded beads 50 ranges from 0.2 lbs/ft³ to 2 lbs/ft³.

In at least one embodiment, steam pin 60 may include a plurality of apertures along the steam pin 60 shaft, thereby distributing steam 64 at a plurality of locations along the shaft. In another embodiment, steam pin 60 may include a plurality of concentric shafts capable of telescoping out in and retracting in, thereby distributing steam 64 at a plurality of locations along the path of the shafts. In yet another embodiment, steam pin 60 includes a plurality concentric shafts, as above, with each shaft section having a plurality of apertures along the shaft section.

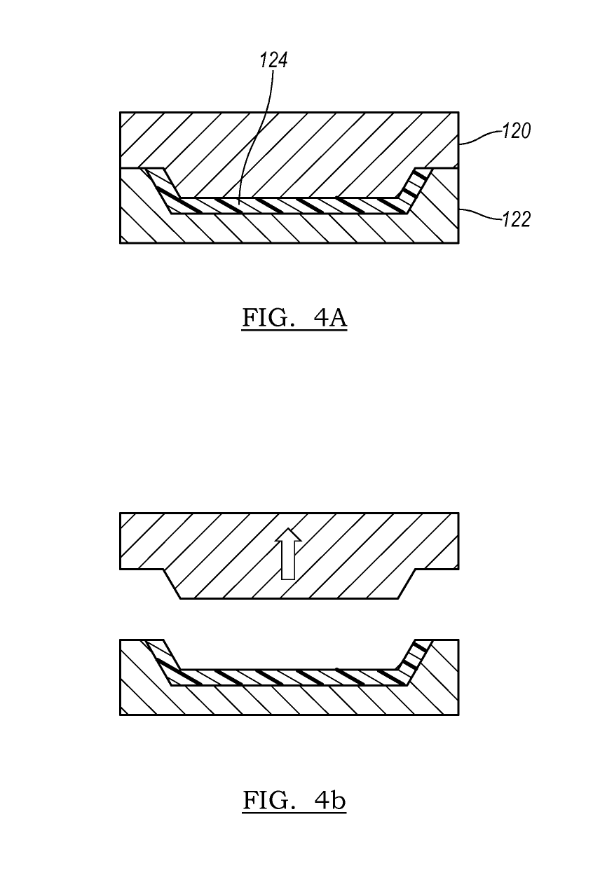

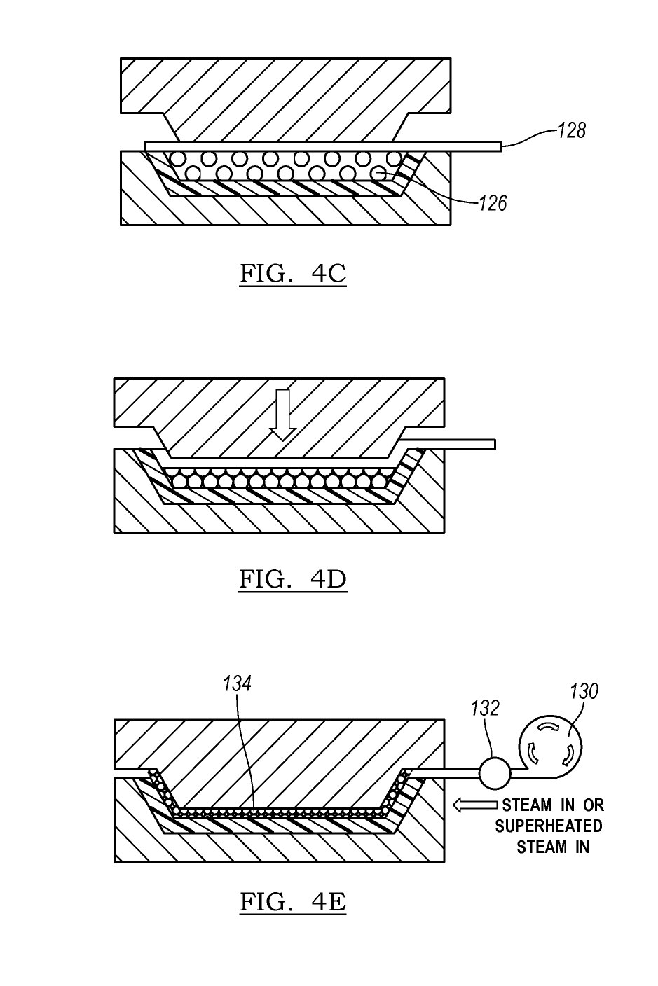

Turning now to FIG. 4A, an injection-molded part 124 is formed between a first mold portion 120 and a second mold portion 122 by any injection-molding method known in the art.

In FIG. 4B, first mold portion 120 is raised to allow insertion of pre-expanded beads 126 and a tube 128, as shown in FIG. 4C. Tube 128 is comprised of a material having a sufficiently high melting point that tube 128 will not melt when exposed to steam or superheated steam. Tube 128 has small apertures 136 capable of permitting steam or superheated steam to infiltrate pre-expanded beads 126.

In FIG. 4D, first mold portion 120 is closed, thereby compressing pre-expanded beads 126 and tube 128. In FIG. 4E, steam or superheated steam from steam source 130 passes through valve 132 which is connected to tube 128. Steam interacts with the pre-expanded beads 126, thereby expanding pre-expanded beads 126 to fully expanded beads forming in-situ foam core 134. In-situ foam core 134 is thermally bonded to injection-molded part 124. Injection-molded part 124 and in-situ foam core 134 comprise a structural plastic article, which can be removed from between first mold portion 120 and second mold portion 122 when at least one of the mold portions separates from the other.

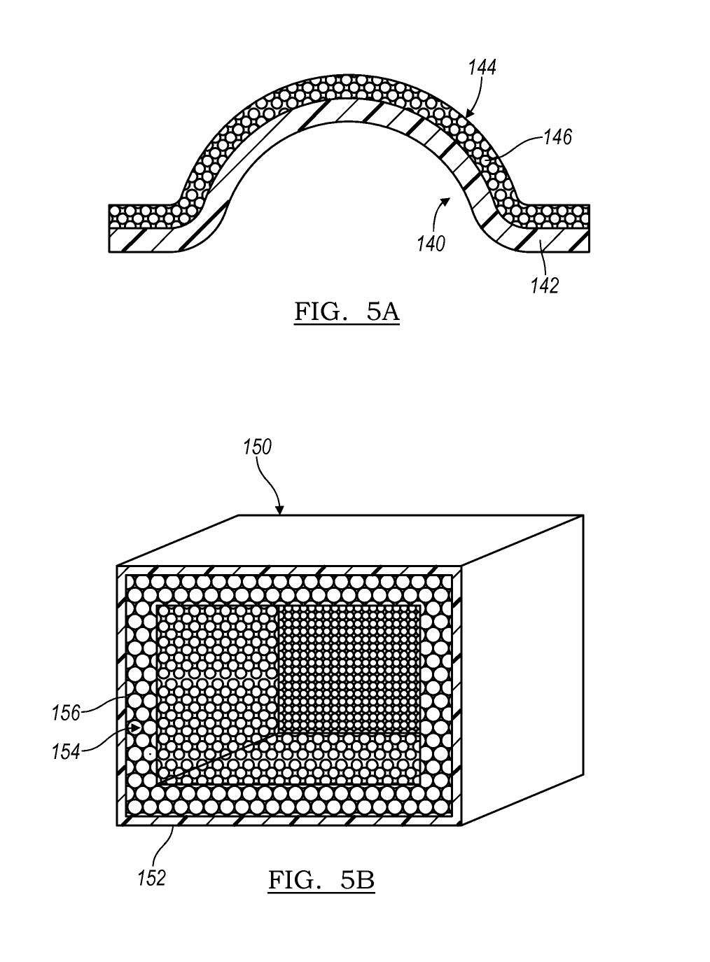

FIGS. 5A and 5B schematically illustrate cross-sectional views of exemplary structural articles. FIG. 5A includes an article 140 having a wall 142 and an in-situ core 144 having a thermal bond 148 therebetween. In-situ foam core 144 is comprised of fully expanded beads 146. FIG. 5B includes a box 150 having a wall 152 bonded to an in-situ foam core 154 with a thermal bond 158 therebetween. The in-situ foam core 154 is comprised of fully expanded beads 156 which were expanded from raw beads or pre-puff beads. Box 150 has sufficient structural strength to be used for class IX shipping containers. In another embodiment, box 150 provides insulative capability to heat transmission of a u-value less than 0.17.

While exemplary embodiments are described above, it is not intended that these embodiments describe all possible forms of the invention. Rather, the words used in the specification awards a description rather than limitation, and it is understood that various changes may be made without departing from the scope and spirit of the invention. Additionally, features of the various implementing embodiments may be combined to form further embodiments of the invention.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

I claim:

1. An article, comprising:
a wall defining a cavity; and
an in-situ foam core disposed within the cavity and having a thermal bond to the wall, wherein the article is structural and the in-situ foam core density ranges from 0.2 lb/ft³ to 20 lbs/ft³.

2. The article of claim 1, wherein the wall is a thin-wall molding having a wall thickness ranging from 1.2 mm to 2.5 mm.

3. The article of claim 1, wherein the in-situ foam core density ranges from 2 lb/ft³ to 6 lbs/ft³.

4. A method for manufacturing a plastic structural article, the method comprising the steps of:
injecting a molten polymer composition through a nozzle into a mold having a first mold portion and a second mold portion, the first and second mold portions defining a first cavity within the mold;
injecting a first fluid from a first fluid source into the first cavity that is partially filled with the molten polymer composition by pushing molten polymer composition towards the walls of mold and a spillover trap forming a second cavity defined by the molten composition adjacent to the walls;
cooling the molten polymer composition sufficiently such that a hollow article is formed and is self-supporting;
removing the first fluid from the second cavity;
cutting an aperture in the wall of the hollow article into the second cavity; dispensing a plurality of pre-expanded beads through the aperture into the second cavity;
injecting a second fluid into the pre-expanded beads;
expanding the pre-expanded beads to fully expanded beads forming an in-situ foam core thermally bonded to the wall; and
releasing the structural plastic article from the mold.
